(19) United States
(12) Patent Application Publication
(10) Pub. No.: US 2018/0058610 A1
(43) Pub. Date: Mar. 1, 2018

(54) Tubular Securing Device

(71) Applicant: Broken W Enterprises LLC, Comanche, OK (US)

(72) Inventor: Gary Don Williams, Comanche, OK (US)

(73) Assignee: Broken W Enterprises LLC, Comanche, OK (US)

(21) Appl. No.: 15/253,045

(22) Filed: Aug. 31, 2016

(51) Int. Cl. F16L 3/22

(52) U.S. Cl. CPC F16L 3/22

(57) ABSTRACT

Systems, methods, and devices for securing tubulars. A tubular securing device may include a slip coupler, wherein the slip coupler is configured to attach to a drain pipe; and at least one ear, wherein the at least one ear is attachable to the slip coupler, wherein the at least one ear comprises at least one passage configured to secure a water line.

### BACKGROUND

Methods of building construction are known in the art in which the foundation of a building may be constructed by first building a framework of form boards and then pouring concrete within the framework. Form boards may be employed, in this regard, in order achieve a desired shape of the concrete (e.g., concrete slab). Typically, when constructing such a concrete structure, it may be desirable that the plumbing be embedded in the concrete for various reasons such as, for example, to achieve plumbing stability and space efficiency.

For this reason, various devices and methods have been employed in the construction art in order to provide mechanical support to a desired configuration of pipes until the concrete (e.g., for a foundation) may be poured and have a sufficient time to set or harden, thereby securing the pipes in a permanent configuration. Securing the pipes in a permanent configuration may allow for accurate measurements for blue prints regarding framing and wall construction. Current methods typically employed for this purpose may involve driving lengths of rebar into the ground and then taping sections of pipe to the rebar in order to provide structural support to the pipe configuration. Because the rebar and tape are typically removed prior to the pouring of concrete so that footers may be dug, the pipe or pipes may often sag, and unless repositioned may result in a plumbing configuration which may be permanently crooked because the plumbing may later become permanently fixed in the concrete. Often, this sagging can contribute to future pipe leaks or low water pressure on the water side or backfall and slow draining or stoppage on the drain line side, and is thus highly undesirable.

In view of the above, it is apparent that there exists a need in the art for a tubular securing devices which mitigates or solves the aforementioned problems in the construction art.

### SUMMARY

The present disclosure relates to systems, methods, and devices for securing tubulars. In certain embodiments, a tubular securing device may include a slip coupler, wherein the slip coupler may be configured to attach to a drain pipe. The tubular device may also include at least one ear, wherein the at least one ear may be attachable to the slip coupler, wherein the at least one ear may include at least one passage configured to secure a water line. Additionally, a tubular securing device may include a slip coupler, wherein the slip coupler may be configured to attach to a drain pipe. The tubular securing device may also include at least one ear, wherein the at least one ear may include at least one passage configured to secure a water line and at least one curved sleeve, wherein the at least one curved sleeve may be configured to secure a water line.

In other embodiments, a method for securing tubulars may include installing a tubular securing device on a drain pipe, wherein the tubular securing device may include a slip coupler and at least one ear, wherein the installing may include disposing the slip coupler over the drain pipe. The method may also include placing water lines through at least one ear.

### BRIEF DESCRIPTION OF THE DRAWINGS

These drawings illustrate certain aspects of some examples of the present disclosure, and should not be used to limit or define the disclosure.

FIG. 1 is a schematic illustration of a tubular securing device in accordance with embodiments of the present disclosure.

FIG. 2 is a schematic illustration of a top view of a slip coupler in accordance with embodiments of the present disclosure.

FIG. 3 is a schematic illustration of a side view of a slip coupler in accordance with embodiments of the present disclosure.

FIG. 4 is a schematic illustration of a side view of an ear in accordance with embodiments of the present disclosure.

FIG. 5 is a schematic illustration of a top view of an ear in accordance with embodiments of the present disclosure.

FIG. 6 is a schematic illustration of a sleeve coupling portion of an ear in accordance with embodiments of the present disclosure.

FIG. 7 is a schematic illustration of insertion of a sleeve into an ear in accordance with embodiments of the present disclosure.

FIG. 8 is a schematic illustration of a sleeve in accordance with embodiments of the present disclosure.

FIG. 9 is a schematic illustration of ears and a slip coupler as one solid piece in accordance with embodiments of the present disclosure.

### DETAILED DESCRIPTION

This disclosure generally relates to a device for supporting the pipes of a plumbing system, for example, during the construction of a concrete structure. More specifically, this disclosure may relate to a tubular securing device for tubulars, such as, for example, water lines and drain lines within a residential and/or commercial structure (e.g., buildings). Water lines may include cross-linked polyethylene (“PEX” or “XLPE”) piping. PEX piping may be utilized in building piping, hydronic radiant heating and cooling systems, domestic water piping, and insulation for high voltage electrical cables. It may also be used for natural gas and offshore oil applications, chemical transportation, and transportation of sewage and slurries. PEX may be an alternative to polyvinyl chloride (PVC), chlorinated polyvinyl chloride (CPVC) or copper tubing for use as residential water pipes. Drain lines (e.g., drain pipes) may include piping made from PVC and/or CPVC. Drain lines may extend vertically from a sewage/drainage line up through the building and connect to drainage plumbing within the building (e.g., sinks, toilets, tubs).

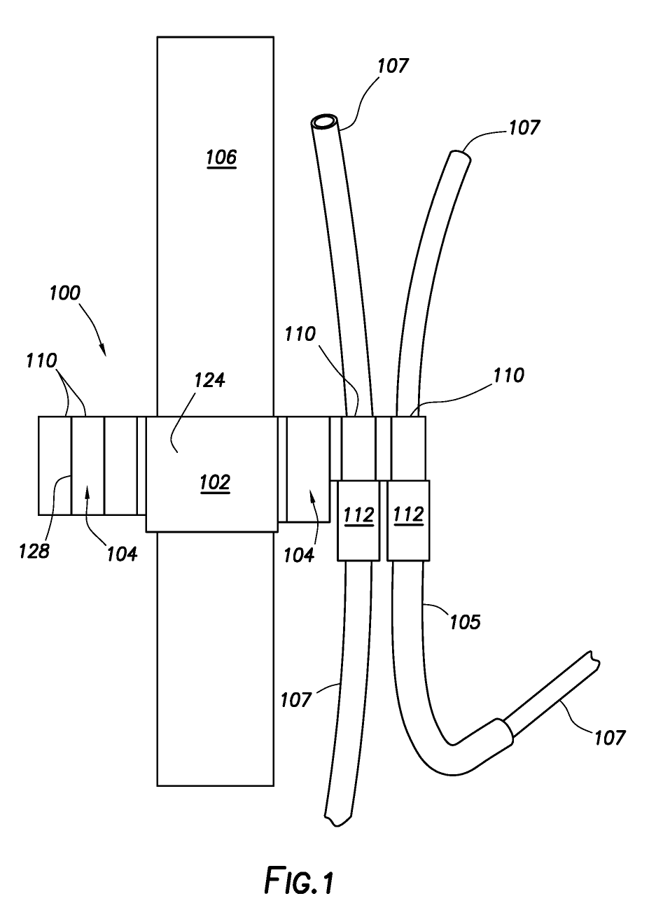

As shown in the drawings for purposes of illustration, an improved tubular securing device referred to generally in FIG. 1 by the reference number 100, is provided for securing tubulars (e.g., water lines, drain lines) in place during building construction. The tubular securing device 100 may be specifically designed to be of simplified construction, inexpensive to manufacture, and easy to use.

FIG. 1 illustrates a tubular securing device 100. Tubular securing device 100 may be made from a material such as, for example, PVC, CPVC, plastic, rubber or any combinations thereof. Tubular securing device 100 may include slip coupler 102, at least one ear 104, and at least one sleeve 105. Slip coupler 102 may be installed on or “slipped” over drain pipe 106. Slip coupler 102 may be disposed over drain pipe 106. By way of example, slip coupler 102 may be interference fitted to drain pipe 106. An interference fit, also known as a press fit or friction fit, may be a fastening between two parts (e.g., slip coupler 102 and drain pipe 106) which may be achieved by friction after the parts are pushed together, rather than by any other means of fastening. Alternatively, other suitable means of fastening slip coupler 102 to drain pipe 106 may be used. Slip coupler 102 may generally be of a cylindrical shape, thereby allowing it to fit on drain pipe 106 which may be of a cylindrical shape with an outer diameter ranging from about 1.5 inches to about 6 inches, for example. Drain pipe 106 may be positioned in a building where it extends upwards towards the roof of the building from a concrete slab (not shown). The concrete slab may be a floor in a multi-story building or the foundation of the building. Additionally, drain pipe 106 may be fluidly coupled to an underground (i.e., below the concrete slab) sewage or drainage system. Water lines 107 may be utilized for bringing water into the building and/or to a desired location in the building.

Water lines 107 may be positioned adjacent to the drain pipe 106. Water lines 107 may include a hot water line and/or a cold water line. One end of each of the water lines 107 may be fluidly coupled to a water source (not shown) such as, for example, city water or well water, whereas, another end of each of the water lines 107 may be fluidly coupled to the plumbing within the building (e.g., toilets, faucets, showers). Similar to the positioning of drain pipe 106, water lines 107 may be positioned in a building where they extend upwards from a concrete slab. The water lines 107 may pass through ears 104 and extend upwards towards the roof of the building, as illustrated in FIG. 1. Ears 104 may include cylindrical passages 110, thereby allowing passing and securing of water lines 107. Each cylindrical passage 110 may include a sleeve coupling portion 112 located on a bottom portion of each cylindrical passage 110. Sleeve coupling portion 112 may be of a cylindrical shape and may allow for an interference fitting of sleeve 105 into sleeve coupling portion 112. Sleeve 105 may be configured for insertion into sleeve coupling portion 112. The ears 104 may be positioned adjacent to slip coupler 102 and may be coupled to slip coupler. In some embodiments, ears 104 may be interference fitted (e.g., slid and/or snapped into place) into slip coupler 102. In the illustrated embodiment, a pair of ears 104 extends in opposite directions from either side of slip coupler 102. The cylindrical passages 110 (including sleeve coupling portions 112) in conjunction with sleeves 105 may allow for a suitable positioning of water lines 107. Sleeves 105 may include a tubular structure which may be curved in order to properly align water lines 107 into the ears 104 (via sleeve coupling portions 112 and cylindrical passages 110). The sleeves 105 may prevent kinks, bends, and/or twists in the water lines 107 as the water lines 107 pass from the foundation/floor through ears 104. An upper portion of each sleeve 105 may be positioned/inserted into sleeve coupling portion 112. In some embodiments, each sleeve 105 may be interference fitted into sleeve coupling portion 112, whereas, a bottom portion of each sleeve 105 may be positioned flat in the foundation/floor, thereby allowing passage of water lines 107 from the foundation/floor upwards through each sleeve coupling portion 112 and cylindrical passage 110. After the water lines 107 are passed though and secured within sleeves 105 (via sleeve coupling portions 112 and cylindrical passages 110, as shown in FIG. 1), concrete may be poured over the bottom portion of sleeves 105 and water lines 107 to form a concrete slab (e.g., foundation/floor). The aforementioned configuration may be repeated on multiple stories/levels of a building. Each component of tubular securing device 100 is further described in more detail below.

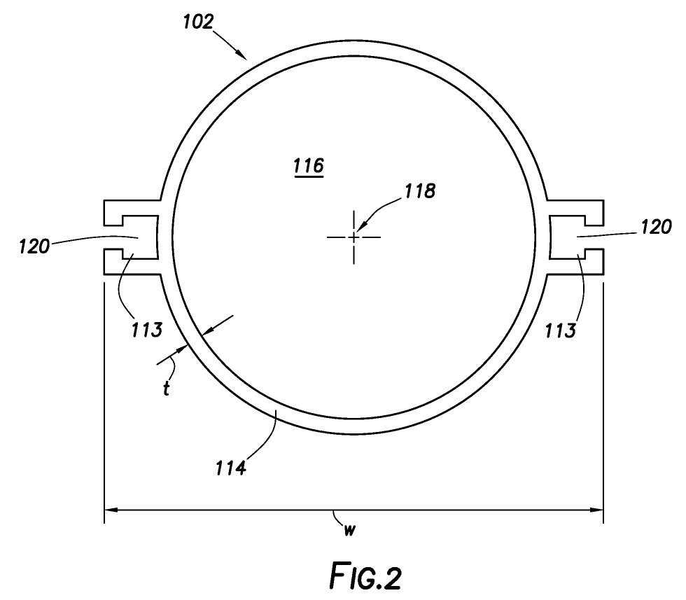

FIG. 2 illustrates a top view of slip coupler 102. As mentioned above, slip coupler 102 may be installed on a drain pipe 106 (e.g., shown on FIG. 1). Slip coupler 102 may be made from a material such as, for example, PVC, CPVC, plastic, rubber or any combinations thereof slip coupler 102 may be hollow (e.g., hollow space 116) and of a cylindrical shape with an inner diameter ranging from about 1.5 inches to about 6 inches. Slip coupler 102 may include at least two slots 113 along cylindrical portion 114 of slip coupler 102. Slots 113 may extend outwardly (e.g., away from center 118 of hollow space 116) from cylindrical portion 114 and may comprise “C” shape apertures 120 which may extend from the top of slots 113 to the bottom of slots 113, as illustrated in FIG. 2. Slots 113 may be configured to allow ears 104 (shown on FIG. 1) to slide down into slots 113 (via apertures 120).

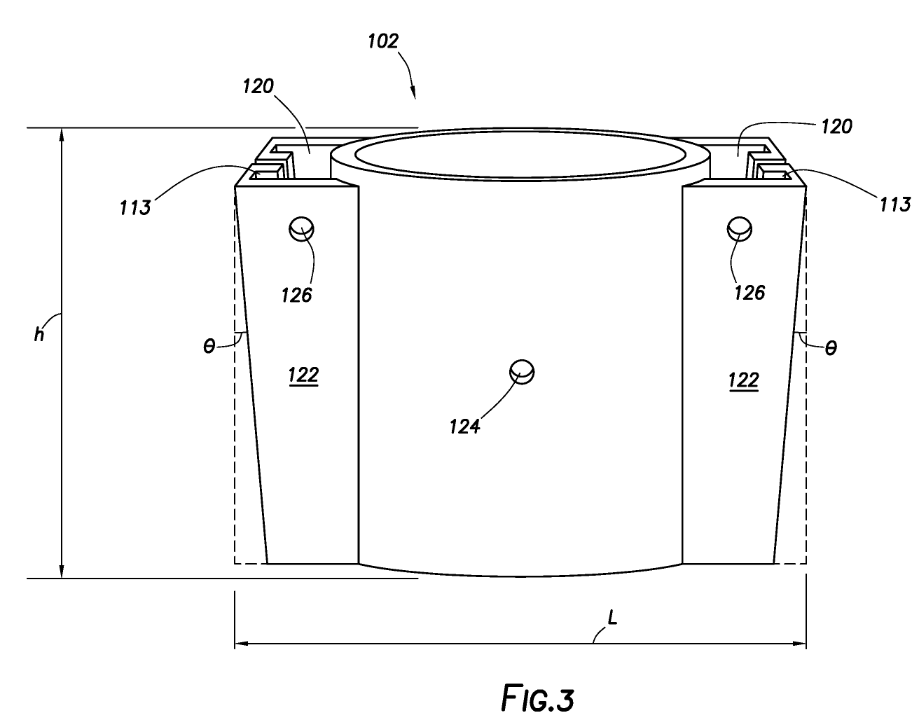

Referring now to FIG. 3 (side view of slip coupler 102), the slots 113 may be angled, thereby forming wedges 122 on lateral portions of slip coupler 102. The angle θ of slots 113 may range from about 10° to about 45°. Slots 113 may extend from the top of slip coupler 102 to the bottom of slip coupler 102. Wedges 122 may assist in providing an interference fit of ears 104 as ears 104 are slid/snapped into slip coupler 102. The length (L) of slip coupler 102 may range from about 1 inch to about 5 inches. The width (w) of slip coupler 102 may range from about 1 inch to about 5 inches, as shown on FIG. 2. The height (h) of slip coupler 102 may range from about 2 inches to about 5 inches. The thickness (t) of slip coupler 102 may range from about ⅛ inch to about ½ inch, as shown on FIG. 2. Slip coupler 102 may include set screw holes 124 and 126. Set screw hole 124 may allow slip coupler 102 to be additionally secured to drain pipe 106 with a screw (not shown) that may be placed through set screw hole 124 and tightened by a wing nut, for example. Set screw holes 126 may allow ears 104 to be additionally secured to slip coupler 102 with a screw that may be placed through each of set screw holes 126 and, in some embodiments, tightened by a wing nut, as well.

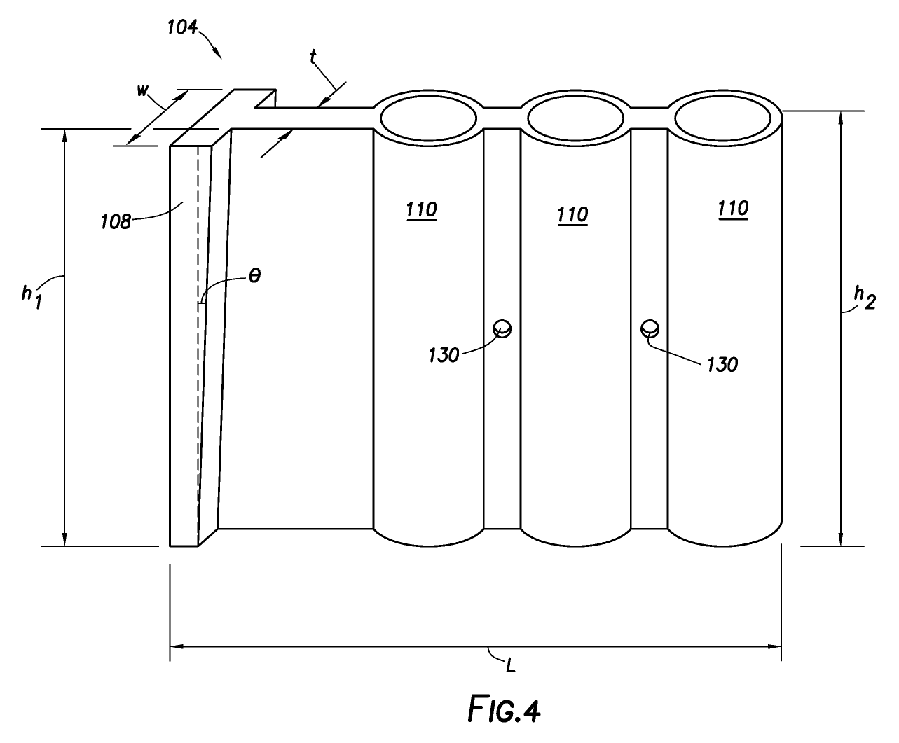

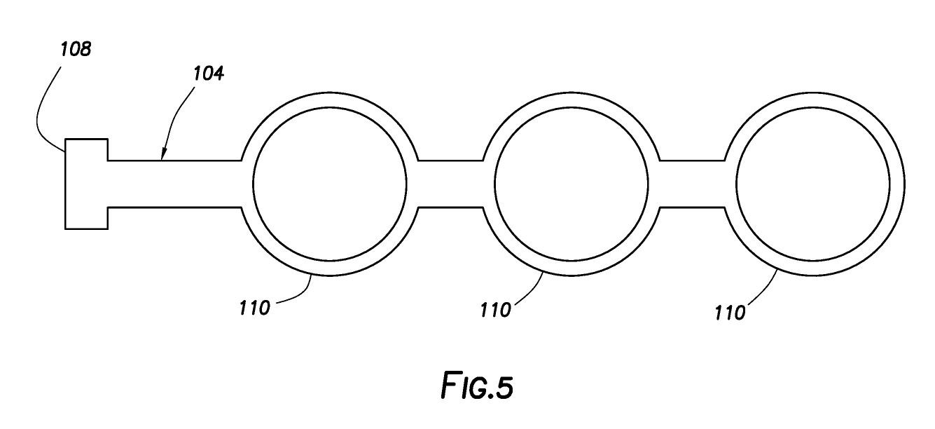

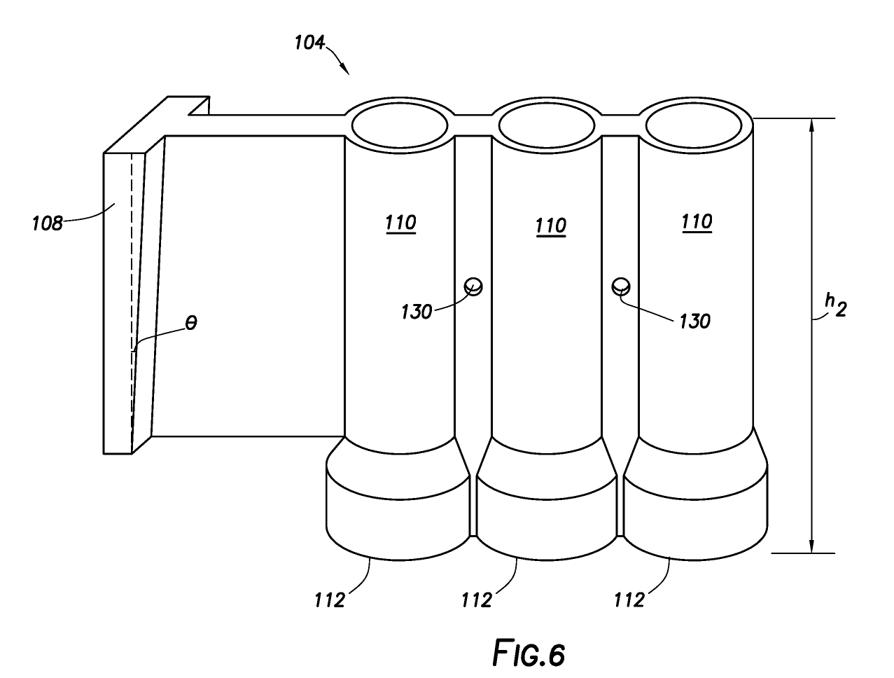

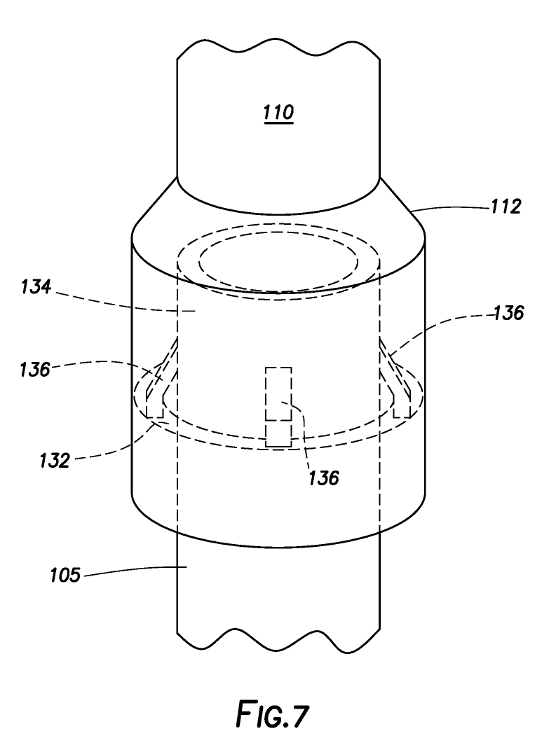

FIG. 4 illustrates a side view of ear 104. Ears 104 may have a generally polygonal (e.g., rectangular) shape and be made from a material such as, for example, PVC, CPVC, plastic, rubber or any combinations thereof. Ears 104 may be a rigid structure that includes sliding portion 108 located on one end of ear 104 and at least one cylindrical passage 110, as shown on FIG. 4. The length (L) of each of ears 104 may range from about 2 inches to about 8 inches. The width (w) of ears 104 may range from about ½ inch to about 2 inches. The height (h₁) of ears 104 may range from about 2 inches to about 5 inches. The thickness (t) of ears 104 may range from about ⅛ inch to about ½ inch. Ears 104 may be attachable/detachable to/from slip coupler 102 via sliding portion 108. In some embodiments, sliding portion 108 may be rigid and wedge shaped and may be slid and interference fitted into slots 113 (e.g., shown on FIG. 2). The wedge shape of sliding portion 108 may be angled, as shown on FIG. 4. The angle θ may range from about 10° to about 45° which may correspond to the angle of slots 113, thereby allowing an effective interference fit of ear 104 (via sliding portion 108) into slip coupler 102. Cylindrical passages 110 may be configured to secure/hold water lines 107 (e.g., PEX piping, shown on FIG. 1) and may have an inner diameter ranging from about ¼ inch to about 2 inches. As mentioned above, the water lines 107 (e.g., shown on FIG. 1) may be placed through cylindrical passages 110, thereby being held in place and secured via cylindrical passages 110. The water lines 107 may be interference fitted into the cylindrical passages 110. The height (h₂) of cylindrical passages 110 may range from about 2 inches to about 5 inches. Although only three cylindrical passages 110 are depicted in FIG. 4, there may be more or less than three cylindrical passages 110. Ear 104 may include screw holes 130 which may be positioned between cylindrical passages 110, as shown in FIG. 4. Screws (not shown) may be disposed through screw holes 130 in order to secure ear 104 to a rigid member (e.g., a wooden stake) if slip coupler 102 is not utilized (i.e. there is no drain pipe 106 for slip coupler 102 to “slip” over). FIG. 5 illustrates a top view of ear 104 including sliding portion 108 and cylindrical passages 110. Cylindrical passages 110 may be positioned adjacent to one another. In alternative embodiments, each of cylindrical passages 110 may include a sleeve coupling portion 112, as illustrated in FIGS. 6 and 7.

Now referring to FIGS. 6 and 7, sleeve coupling portion 112 will be described in more detail in accordance with example embodiments. In some embodiments, sleeve coupling portion 112 may be made from PVC, CPVC, plastic and/or rubber and may include a ridge 132 within sleeve coupling portion 112. As illustrated, sleeve coupling portion 112 may comprise an enlarged diameter as compared to cylindrical passages 110. The ridge 132 may be continuous and extend along the inner diameter of sleeve coupling portion 112. Ridge 132 may protrude from the inner surface of sleeve coupling portion 112. As best seen on FIG. 7, top portion 134 of sleeve 105 may be secured in sleeve coupling portion 112. As illustrated, protrusions 136 may extend from top portion 134. When top portion 134 is inserted into sleeve coupling portion 112, protrusions 136 may lock sleeve 105 against ridge 132 to prevent sleeve 105 from slipping out of sleeve coupling portion 112. Sleeve 105 may be interference fitted into sleeve coupling portion 112, such that sleeve 105 may be rotatable, for example, up to 360°, within sleeve coupling portion 112.

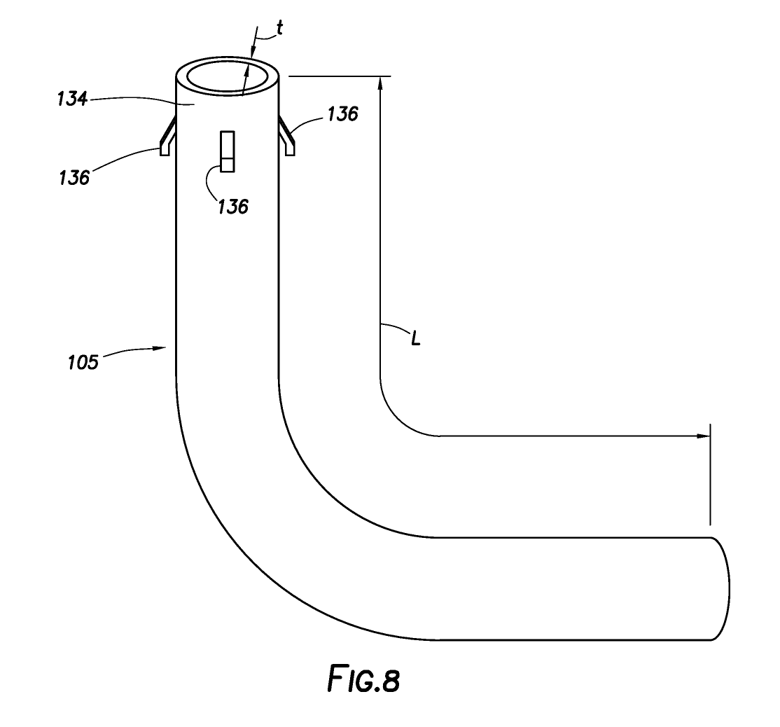

FIG. 8 illustrates sleeve 105. Sleeve 105 may be made from a material such as, for example, PVC, CPVC, plastic, rubber or any combinations thereof sleeve 105 may be attachable/detachable to/from sleeve coupling portion 112. Sleeve 105 may be hollow, have a tubular shape and an inner diameter ranging from about ¼ inch to about 2 inches. The length and thickness of sleeve 105 may range from about 8 inches to about 14 inches and about ⅛ inch to about ½ inch, respectively. Top portion 134 of sleeve 105 may include at least two protrusions 136. Protrusions 136 may be hook shaped and protrude from an exterior surface of sleeve 105. Top portion 134 may be placed/inserted into sleeve coupling portion 112 (shown on FIG. 6) thereby affixing sleeve 105 to a cylindrical passage 110 of ear 104. As mentioned above, sleeve 105 may be curved to prevent any kinks, bends, and/or twists in each of the water lines 107 as each water line 108 is placed through sleeve 105 and through cylindrical passage 110 (shown in FIG. 4). As illustrated, sleeve 105 may include a 90° bend.

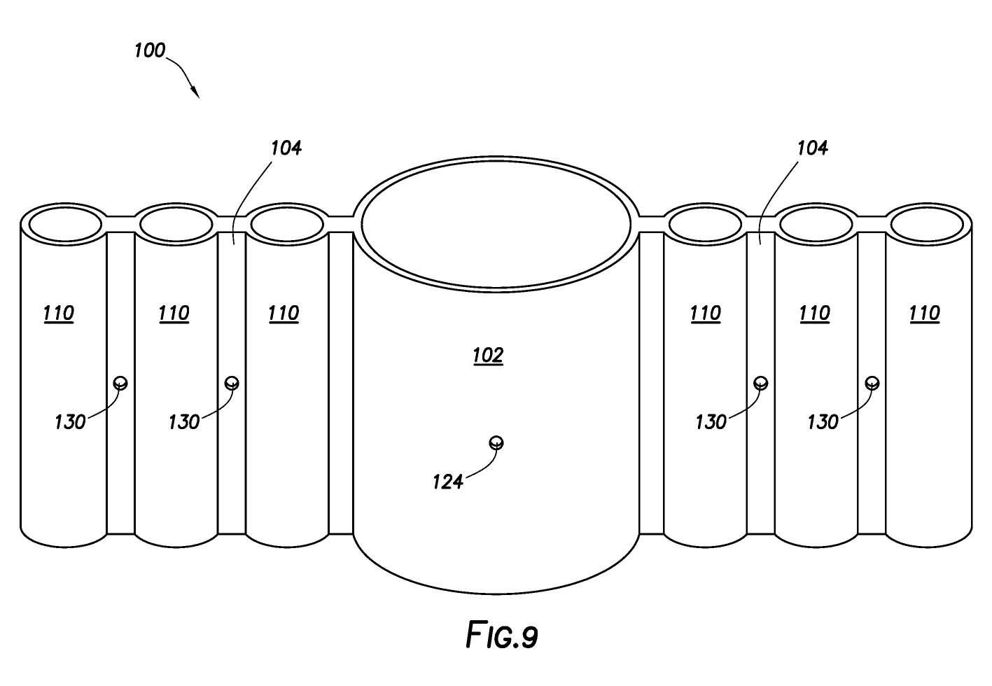

Although the previous description and figures have described and shown tubular securing device 100 as modular (i.e., multiple pieces being put together to form the device), the tubular securing device 100 may be one solid continuous piece that is not modular, as shown in FIG. 9. This one solid continuous piece may be made from a material such as, for example, PVC, CPVC, plastic, rubber or any combinations thereof. FIG. 9 illustrates ears 104 and slip coupler 102 as one solid, rigid, and continuous piece. Slip coupler 102 may be hollow (e.g., hollow space 116) and of a cylindrical shape, for example, with an inner diameter ranging from about 1.5 inches to about 6 inches. Slip coupler 102 may include set screw hole 124. Set screw hole 124 may allow slip coupler 102 to be additionally secured to drain pipe 106 with a screw that may be placed through screw hole 124 and tightened by a wing nut. Ear 104 may include at least one cylindrical passage 110. The water lines 107 (e.g., shown on FIG. 1) may be placed through cylindrical passages 110, thereby being held in place and secured via cylindrical passages 110. The water lines 107 may be interference fitted into the cylindrical passages 110. Although only three cylindrical passages 110 are depicted in FIG. 9, there may be more or less than three cylindrical passages 110. Ear 104 may include screw holes 130 which may be positioned between cylindrical passages 110, as shown in FIG. 9. Screws may be disposed through screw holes 130 in order to secure ear 104 to a rigid member (e.g., a wooden stake). In alternative embodiments, each of cylindrical passages 110 may include a sleeve coupling portion 112. Sleeve coupling portion 112 may include a ridge 132 within sleeve coupling portion 112. The ridge 132 may be continuous and extend along the inner diameter of sleeve coupling portion 112, as shown in FIG. 7, for example. Ridge 132 may protrude from the inner surface of sleeve coupling portion 112. When top portion 134 is inserted into sleeve coupling portion 112, protrusions 136 may lock sleeve 105 against ridge 132 to hold sleeve 105 in place, as shown in FIG. 8.

Although the present invention and its advantages have been described in detail, it should be understood that various changes, substitutions and alterations may be made herein without departing from the spirit and scope of the invention as defined by the appended claims. While apparatus and methods are described in terms of “comprising,” “containing,” “having,” or “including” various components or steps, the apparatus and methods can also “consist essentially of” or “consist of” the various components and steps.

What is claimed is:

1. A tubular securing device for securing tubulars in place during, construction of a structure, comprising:
a slip coupler, wherein the slip coupler is configured to attach to a drain pipe for support during construction of the structure; and
at least one ear, wherein the at least one ear is attachable to the slip coupler, wherein the at least one ear comprises at least one passage configured to secure a water line.

2. The tubular securing device of claim 1, wherein the at least one passage comprises a sleeve coupling portion.

3. The tubular securing device of claim 2, wherein the slip coupler and the at least one ear are made from a material selected from the group consisting of polyvinyl chloride, chlorinated polyvinyl chloride, plastic, rubber and any combinations thereof.

4. The tubular securing device of claim 2, further comprising at least one sleeve configured for insertion into the sleeve coupling portion.

5. The tubular securing device of claim 4, wherein the sleeve is curved.

6. The tubular securing device of claim 5, wherein the sleeve is detachable from the sleeve coupling portion.

7. The tubular securing device of claim 5, wherein the sleeve is configured to secure a water line.

8. The tubular securing device of claim 1, wherein the slip coupler comprises slots.

9. The tubular securing device of claim 8, wherein the at least one ear comprises a sliding portion configured to slide into one of the slots.

10. The tubular securing device of claim 9, wherein the at least one ear is configured to be removably attached to the slip coupler.

11. A tubular securing device for securing tubulars in place during construction of a structure, comprising:
a slip coupler, wherein the slip coupler is configured to attach to a drain pipe for support during construction of the structure;
at least on ear, wherein the at least one ear comprises at least one passage configured to secure a water line; and
at least one curved sleeve, wherein the at least one curved sleeve is configured to secure the water line.

12. The tubular securing device of claim 11, wherein the slip coupler comprises a screw hole.

13. The tubular securing device of claim 11, wherein the slip coupler is of a cylindrical shape.

14. The tubular securing device of claim 13, wherein an inner diameter of the slip coupler ranges from about 1.5 inches to about 6 inches.

15. The tubular securing device of claim 11, wherein an inner diameter of the at least one passage ranges from about ¼ inch to about 2 inches.

16. The tubular securing device of claim 11, wherein an inner diameter of the at least one curved sleeve ranges from about ¼ inch to about 2 inches.

17. The tubular securing device of claim 11, wherein the at least one ear comprises a screw hole.

18. The tubular securing device of claim 11, wherein the at least one passage is of a cylindrical shape.

19. The tubular securing device of claim 11, wherein the slip coupler, the at least one ear and the at least one curved sleeve are made from a material selected from the group consisting of polyvinyl chloride, chlorinated polyvinyl chloride, plastic, rubber and any combinations thereof.

20. A method for securing tubulars in place during construction of a structure, comprising:
installing a tubular securing device on a drain pipe for support during construction of the structure, wherein the tubular securing device comprises a slip coupler and at least one ear, wherein the installing comprises disposing the slip coupler over the drain pipe; and
placing water lines through the at least one ear.
